(19) United States
(12) Patent Application Publication
(10) Pub. No.: US 2021/0398224 A1
(43) Pub. Date: Dec. 23, 2021

(54) INFORMATION PROCESSING DEVICE, INFORMATION PROCESSING SYSTEM, PROGRAM AND VEHICLE

(71) Applicant: TOYOTA JIDOSHA KABUSHIKI KAISHA, Toyota-shi (JP)

(72) Inventors: Tooru NAKANISHI, Nagakute-shi (JP); Tadashi YAMADA, Toyota-shi (JP); Josuke YAMANE, Nissin-shi (JP); Mitsuhiro MIURA, Toyota-shi (JP); Tomo SASAKI, Toyota-shi (JP); Tomoyuki KOZUKA, Toyota-shi (JP); Tae SUGIMURA, Miyoshi-shi (JP)

(73) Assignee: TOYOTA JIDOSHA KABUSHIKI KAISHA, Toyota-shi (JP)

(21) Appl. No.: 17/237,253

(22) Filed: Apr. 22, 2021

(30) Foreign Application Priority Data
Jun. 22, 2020 (JP) 2020-107197

(51) Int. Cl. G06Q 40/08; G06K 9/32; G07C 5/00; G08G 1/017; G08G 1/01; B60W 50/04

(52) U.S. Cl. CPC G06Q 40/08; G06K 9/325; G07C 5/008; B60W 2050/046; G08G 1/0112; B60W 50/045; G08G 1/017

(57) ABSTRACT

An information processing device includes a control unit. The control unit acquires traveling information that is obtained in association with driving of a first vehicle and evaluation information about evaluation of the driving of the first vehicle by an occupant of a second vehicle that travels in a periphery of the first vehicle, and decides a premium of an automobile insurance for the driver of the first vehicle, based on a comparison process of the acquired traveling information and the acquired evaluation information.

### CROSS-REFERENCE TO RELATED APPLICATION

This application claims priority to Japanese Patent Application No. 2020-107197 filed on Jun. 22, 2020, incorporated herein by reference in its entirety.

### BACKGROUND

### 1. Technical Field

The present disclosure relates to an information processing device, an information processing system, a program and a vehicle.

### 2. Description of Related Art

Conventionally, there has been known a technology for deciding a premium of an automobile insurance for a driver of a vehicle. For example, Japanese Patent No. 6261637 discloses an insurance condition deciding device that can flexibly decide an insurance condition based on experience of a user, even when the user newly enters an insurance.

### SUMMARY

In the related art, there has not been sufficiently considered a technology in which, in the decision of the premium of the automobile insurance, the premium is decided based on evaluation information about driving of the vehicle from another person in addition to traveling information about the vehicle. Accordingly, the objectivity of the decided premium is low.

The present disclosure has been made in view of such a circumstance, and an object of the present disclosure is to enhance the objectivity of the premium of the automobile insurance that is decided for the driver of the vehicle.

An information processing device according to an embodiment of the present disclosure includes a control unit configured to acquire traveling information and evaluation information, and to decide a premium of an automobile insurance for a driver of a first vehicle, based on a comparison process of the acquired traveling information and the acquired evaluation information, the traveling information being obtained in association with driving of the first vehicle, the evaluation information being information about evaluation of the driving of the first vehicle by an occupant of a second vehicle that travels in a periphery of the first vehicle.

A program according to an embodiment of the present disclosure causes an information processing device to execute an operation including: acquiring traveling information, the traveling information being obtained in association with driving of a first vehicle; acquiring evaluation information, the evaluation information being information about evaluation of the driving of the first vehicle by an occupant of a second vehicle that travels in a periphery of the first vehicle; executing a comparison process of the acquired traveling information and the acquired evaluation information; and deciding a premium of an automobile insurance for a driver of the first vehicle, based on the comparison process.

A vehicle according to an embodiment of the present disclosure includes a control unit configured to acquire traveling information and evaluation information, and to decide a premium of an automobile insurance for a driver of the vehicle, based on a comparison process of the acquired traveling information and the acquired evaluation information, the traveling information being obtained in association with driving of the vehicle, the evaluation information being information about evaluation of the driving of the vehicle by an occupant of another vehicle that travels in a periphery of the vehicle.

An information processing device, an information processing system, a program and a vehicle according to an embodiment of the present disclosure make it possible to enhance the objectivity of the premium of the automobile insurance that is decided for the driver of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram illustrating a configuration of an information processing system that includes an information processing device according to an embodiment of the present disclosure;

FIG. 2 is a functional block diagram illustrating schematic configurations of the information processing device, a first vehicle, a second vehicle and a terminal device in FIG. 1;

FIG. 3 is a schematic diagram illustrating an exemplary traveling image that is output on an output unit of the second vehicle in FIG. 2;

FIG. 4 is a first diagram for describing an exemplary process by a control unit of the information processing device in FIG. 2;

FIG. 5 is a second diagram for describing the exemplary process by the control unit of the information processing device in FIG. 2;

FIG. 6 is a third diagram for describing the exemplary process by the control unit of the information processing device in FIG. 2;

FIG. 7 is a sequence diagram for describing an exemplary information processing method that is executed by the information processing system in FIG. 1;

FIG. 8 is a flowchart for describing a first example of an information processing method that is executed by the information processing device in FIG. 1;

FIG. 9 is a flowchart for describing a second example of the information processing method that is executed by the information processing device in FIG. 1; and

FIG. 10 is a flowchart for describing a third example of the information processing method that is executed by the information processing device in FIG. 1.

### DETAILED DESCRIPTION OF EMBODIMENTS

Embodiments of the present disclosure will be described below with reference to the drawings.

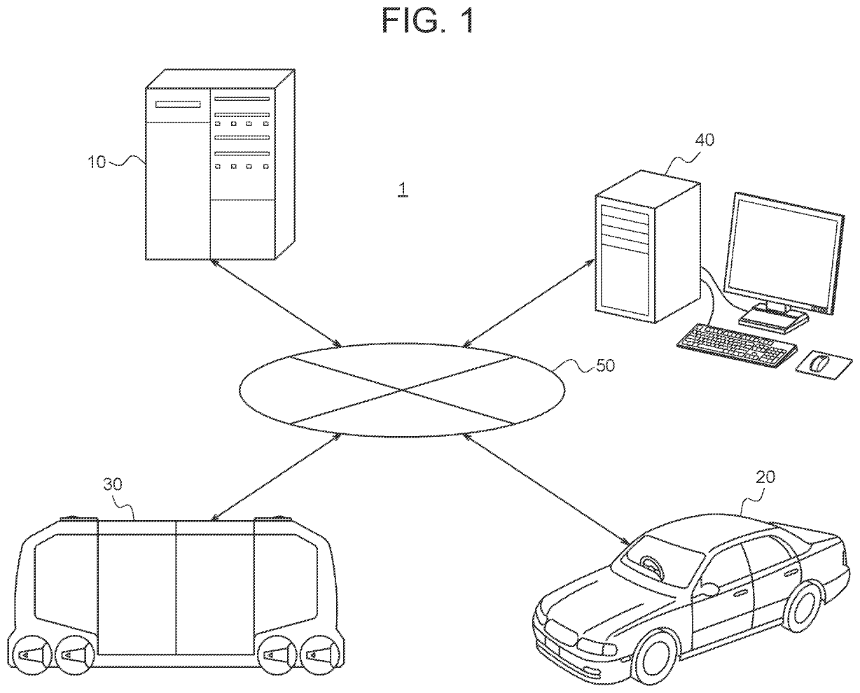

FIG. 1 is a configuration diagram illustrating a configuration of an information processing system 1 that includes an information processing device 10 according to an embodiment of the present disclosure. An outline of the information processing system 1 that includes the information processing device 10 according to the embodiment of the present disclosure will be mainly described with reference to FIG. 1. The information processing system 1 includes a first vehicle 20, a second vehicle 30 and a terminal device 40, in addition to the information processing device 10.

In FIG. 1, for simplification of description, one information processing device 10, one first vehicle 20, one second vehicle 30 and one terminal device 40 are illustrated. However, in the information processing system 1, the number of information processing devices 10, the number of first vehicles 20, the number of second vehicles 30 and the number of terminal devices 40 may be two or more. For example, a driver may continuously use an identical first vehicle 20, or may use an arbitrary different first vehicle 20 of a plurality of first vehicles 20 at each riding or at a predetermined interval. For example, an occupant may continuously use an identical second vehicle 30, or may use an arbitrary different second vehicle 30 of a plurality of second vehicles 30 at each riding or at a predetermined interval.

The number of occupants of the second vehicle 30 may be one, or may be two or more. Each of the information processing device 10, the first vehicle 20, the second vehicle 30 and the terminal device 40 is communicably connected to a network 50 that includes a mobile communication network and the Internet, for example.

The information processing device 10 is one server device or a plurality of server devices that can communicate with each other. Without being limited to them, the information processing device 10 may be an arbitrary general-purpose electronic device such as a PC (Personal Computer) or a smartphone, or may be another electronic device dedicated for the information processing system 1.

For example, the first vehicle 20 is an automobile. Without being limited to this, the first vehicle 20 may be an arbitrary vehicle that can travel with the driving by the driver while a human is in the first vehicle 20 as the driver. For example, the first vehicle 20 is a vehicle that performs automatic driving. The automatic driving includes levels 1 to 5 defined by SAE (Society of Automotive Engineers), for example, but without being limited to them, may be arbitrarily defined.

For example, the second vehicle 30 is an automobile. Without being limited to this, the second vehicle 30 may be an arbitrary vehicle that can travel while a human is in the second vehicle 30. For example, the second vehicle 30 is a vehicle that performs automatic driving. The automatic driving includes the levels 1 to 5 defined by SAE, for example, but without being limited to them, may be arbitrarily defined. The second vehicle 30 is not limited to the vehicle that performs automatic driving, and may be an arbitrary vehicle that is driven by a driver.

For example, the terminal device 40 is a general-purpose electronic device such as a PC or a smartphone. For example, the terminal device 40 is an electronic device that is used by a staff of an insurance company. The insurance company provides an automobile insurance service that the driver of the first vehicle 20 takes out. Without being limited to them, the terminal device 40 may be one server device that is used in the insurance company, or a plurality of server devices that can communicate with each other and that is used in the insurance company, or may be an electronic device dedicated for the information processing system 1.

As an outline of the embodiment, the information processing device 10 acquires traveling information that is obtained in association with driving of the first vehicle 20. In the present specification, for example, the “traveling information” includes arbitrary information that is acquired by the first vehicle 20 when the first vehicle 20 travels and that is obtained in association with the driving of the first vehicle 20.

For example, the “traveling information” includes the speed, acceleration, deceleration, angular velocity, inter-vehicle distance, shift lever operation, steering angle of the first vehicle 20, a traveling image that is obtained by picking up an exterior of the first vehicle 20 using an in-vehicle camera, and the like.

The information processing device 10 acquires evaluation information about evaluation of the driving of the first vehicle 20 by the occupant of the second vehicle 30 that travels in a periphery of the first vehicle 20. In the present specification, for example, the “evaluation information” includes a content of five-grade evaluation for the driving of the first vehicle 20. In the five-grade evaluation, the evaluation is higher as the numeral is larger. Without being limited to this, for example, the “evaluation information” may include a score of 0 points to 100 points. For example, the “evaluation information” may include the number of times the occupant pressed a “Like” button. For example, the “evaluation information” may include input information from the occupant that is based on “Like” buttons corresponding to evaluation degrees such as “Very Like” and “Like”.

The information processing device 10 executes a comparison process of the acquired traveling information and the acquired evaluation information. The information processing device 10 decides a premium of the automobile insurance for the driver of the first vehicle 20, based on the comparison process.

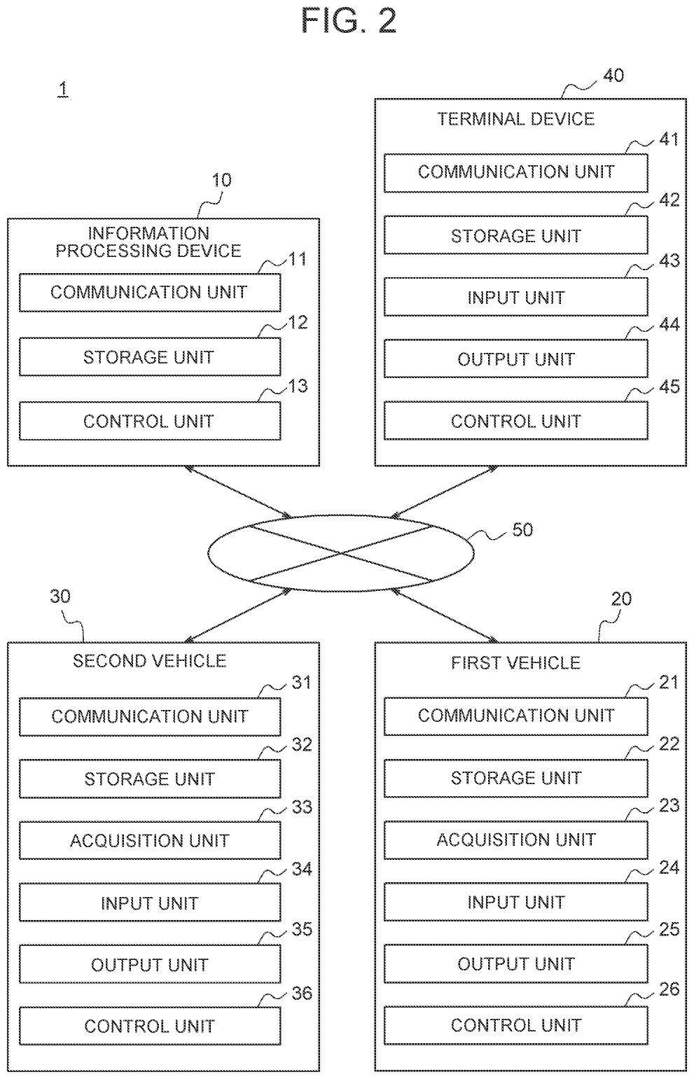

Next, configurations of the information processing device 10, the first vehicle 20, the second vehicle 30 and the terminal device 40 that are included in the information processing system 1 will be mainly described with reference to FIG. 2. FIG. 2 is a functional block diagram illustrating schematic configurations of the information processing device 10, the first vehicle 20, the second vehicle 30 and the terminal device 40 in FIG. 1.

As illustrated in FIG. 2, the first vehicle 20 includes a communication unit 21, a storage unit 22, an acquisition unit 23, an input unit 24, an output unit 25, and a control unit 26. The communication unit 21, the storage unit 22, the acquisition unit 23, the input unit 24, the output unit 25 and the control unit 26 are communicably connected to each other, for example, through an in-vehicle network such as a CAN (Controller Area Network), or through a dedicated line.

The communication unit 21 includes a communication module that performs connection to the network 50. For example, the communication unit 21 may include a communication module that supports a mobile communication standard such as 4G (4th Generation) and 5G (5th Generation). The first vehicle 20 is connected to the network 50 through the communication unit 21. The communication unit 21 sends and receives a variety of information through the network 50.

The storage unit 22 is a semiconductor memory, a magnetic memory or an optical memory, for example, but is not limited to them. For example, the storage unit 22 may function as a main storage device, an auxiliary storage device or a cache memory. The storage unit 22 stores arbitrary information that is used for the operation of the first vehicle 20. For example, the storage unit 22 stores the traveling information acquired by the acquisition unit 23. In addition, for example, the storage unit 22 may store a system program, an application program, a variety of information received by the communication unit 21, and the like. For example, the information stored in the storage unit 22 may be updated to information that is received from the network 50 through the communication unit 21.

The acquisition unit 23 includes an arbitrary module that can acquire a variety of traveling information. For example, the acquisition unit 23 may include a sensor module that can acquire the variety of traveling information. For example, the acquisition unit 23 may include a speed sensor, an acceleration sensor, an angular sensor, a LIDAR (Light Detection and Ranging, or Laser Imaging Detection and Ranging), a shift lever position sensor, a steering angle sensor, an outside-vehicle camera that is installed on the outside of a vehicle cabin of the first vehicle 20, that is connected to the CAN and that can pick up the exterior of the first vehicle 20, and the like.

The acquisition unit 23 includes one or more receivers that correspond to an arbitrary satellite positioning system. For example, the acquisition unit 23 may include a GPS (Global Positioning System) receiver. The acquisition unit 23 acquires a measured value of the position of the first vehicle 20 as position information. The acquisition unit 23 may acquire the position information about the first vehicle 20 constantly, or may acquire the position information about the first vehicle 20 periodically or randomly.

In the present specification, for example, the “position information” includes address, latitude, longitude, altitude, and individual information about the vehicle that is associated with the information about the address, the latitude, the longitude and the altitude. In the present specification, for example, the “individual information” includes number information of a number plate of the vehicle. For example, the “individual information” includes the numbers on the number plate of the vehicle. Without being limited to this, for example, the “individual number” may include an arbitrary individual number that is associated with the numbers on the number plate of the vehicle. In the present specification, for example, the “individual number” includes an arbitrary number that is obtained by conversion with a predetermined protocol that is previously set between the information processing device 10 and the vehicle.

In addition, the acquisition unit 23 may include an arbitrary module that can acquire a variety of occupant information. In the present specification, for example, the “occupant information” includes the number of occupants, age, sex, body weight, physical size, clothes, race, conversation content, behavior and the like. For example, the acquisition unit 23 may include a seating sensor that is installed on a seat of the first vehicle 20. The seat of the first vehicle 20 includes a driver's seat, an assistant driver's seat and a rear seat down which occupants sit. For example, the acquisition unit 23 may include an in-vehicle camera, a microphone and another arbitrary sensor module that are installed in the vehicle cabin of the first vehicle 20 and that are connected to the CAN.

For example, the input unit 24 includes one or more input interfaces that accept an occupant's input operation to information output by the output unit 25 and that acquire input information based on the occupant's input operation. For example, the input unit 24 includes a car navigation device that constitutes the output unit 25. For example, the input unit 24 includes a touchscreen provided integrally with a liquid crystal display that constitutes the car navigation device. For example, the car navigation device that constitutes the input unit 24 accepts the occupant's input operation based on an occupant's touch operation.

Without being limited to this, the input unit 24 may include an arbitrary input interface that can acquire the input information based on the occupant's input operation by detecting the occupant's input operation. For example, the input unit 24 may include a physical key, a capacitance key, a microphone that accepts a voice input, and the like.

For example, the output unit 25 outputs information received by the communication unit 21, and the like, to an occupant in the vehicle cabin of the first vehicle 20. For example, the output unit 25 includes a car navigation device. For example, the output unit 25 includes an output device such as a liquid crystal display that constitutes the car navigation device. For example, the car navigation device that constitutes the output unit 25 outputs information through at least one of an image and a voice.

Without being limited to this, the output unit 25 may include an arbitrary output device that gives an influence on at least one of the visual sense and auditory sense of the occupant of the first vehicle 20. For example, the output unit 25 may include another arbitrary voice output device that is other than the car navigation device and that gives an influence mainly on the auditory sense of the occupant of the first vehicle 20. For example, the output unit 25 may include another arbitrary image output device that is other than the car navigation device and that gives an influence mainly on the visual sense of the occupant of the first vehicle 20.

The control unit 26 includes one or more processors. The “processor” is a general-purpose processor, or a processor dedicated for a particular process, but is not limited to them. For example, the control unit 26 may include an ECU (Electronic Control Unit). The control unit 26 is communicably connected to constituent units that constitute the first vehicle 20, and controls the whole operation of the first vehicle 20.

Using the acquisition unit 23, the control unit 26 acquires the traveling information that is obtained in association with the driving of the first vehicle 20. The control unit 26 sends the traveling information acquired by the acquisition unit 23, to the information processing device 10, through the communication unit 21 and the network 50. Using the acquisition unit 23, the control unit 26 acquires the position information about the first vehicle 20. The control unit 26 may send the position information about the first vehicle 20 acquired by the acquisition unit 23, to the information processing device 10, through the communication unit 21 and the network 50.

As necessary, the control unit 26 may receive the evaluation information about the evaluation of the driving of the first vehicle 20 by the occupant of the second vehicle 30 that travels in the periphery of the first vehicle 20, from the information processing device 10, through the network 50 and the communication unit 21. Without being limited to this, as necessary, the control unit 26 may receive the evaluation information from the second vehicle 30 through the communication unit 21, by inter-vehicle communication with the second vehicle 30, without using the network 50.

The control unit 26 may receive information about the premium that is the premium of the automobile insurance for the driver of the first vehicle 20 and that is decided by the information processing device 10, from the information processing device 10, through the network 50 and the communication unit 21. The control unit 26 may receive information about a driving method that allows the premium to be decreased and that is decided by the information processing device 10, from the information processing device 10, through the network 50 and the communication unit 21.

Next, the configuration of the second vehicle 30 included in the information processing system 1 will be mainly described. As illustrated in FIG. 2, the second vehicle 30 includes a communication unit 31, a storage unit 32, an acquisition unit 33, an input unit 34, an output unit 35, and a control unit 36. The communication unit 31, the storage unit 32, the acquisition unit 33, the input unit 34, the output unit 35 and the control unit 36 are communicably connected to each other, for example, through an in-vehicle network such as a CAN, or through a dedicated line.

The above descriptions for the communication unit 21, the storage unit 22, the acquisition unit 23, the input unit 24, the output unit 25 and the control unit 26 of the first vehicle 20 can be applied to the communication unit 31, the storage unit 32, the acquisition unit 33, the input unit 34, the output unit 35 and the control unit 36 of the second vehicle 30, respectively. When the constituent unit of the second vehicle 30 can be similarly described by the description for the corresponding constituent unit of the first vehicle 20, the description for the constituent unit of the second vehicle 30 will be omitted, and differences from the first vehicle 20 will be mainly described.

The storage unit 32 stores arbitrary information that is used for the operation of the second vehicle 30. For example, the storage unit 32 stores the evaluation information that is acquired from the occupant using the input unit 34 and the output unit 35. For example, the storage unit 32 stores the traveling image that is taken by the outside-vehicle camera of the second vehicle 30 and that is acquired by the acquisition unit 33. The traveling image contains the number plate of the first vehicle 20.

The acquisition unit 33 includes the outside-vehicle camera and the like. The outside-vehicle camera is installed on the outside of the vehicle cabin of the second vehicle 30, and is connected to the CAN. The outside-vehicle camera can pick up the exterior of the second vehicle 30. The acquisition unit 33 includes one or more receivers that correspond to an arbitrary satellite positioning system. For example, the acquisition unit 33 may include a GPS receiver. The acquisition unit 33 acquires a measured value of the position of the second vehicle 30 as position information. The acquisition unit 33 may acquire the position information about the second vehicle 30 constantly, or may acquire the position information about the second vehicle 30 periodically or randomly.

In addition, the acquisition unit 33 may include an arbitrary module that can acquire a variety of occupant information. For example, the acquisition unit 33 may include a seating sensor that is installed on a seat of the second vehicle 30. The seat of the second vehicle 30 includes a driver's seat, an assistant driver's seat and a rear seat down which occupants sit. For example, the acquisition unit 33 may include an in-vehicle camera, a microphone and another arbitrary sensor module that are installed in the vehicle cabin of the second vehicle 30 and that are connected to the CAN.

For example, the control unit 36 acquires the traveling image picked up by the outside-vehicle camera of the acquisition unit 33. The control unit 36 processes the acquired traveling image. For example, the process includes a process of displaying items to which the occupant of the second vehicle 30 inputs the evaluation information, such that the items are superposed on a plurality of first vehicles 20 that travel in a periphery of the second vehicle 30 and that is shown on the traveling image. The control unit 36 outputs the processed traveling image on the output unit 35.

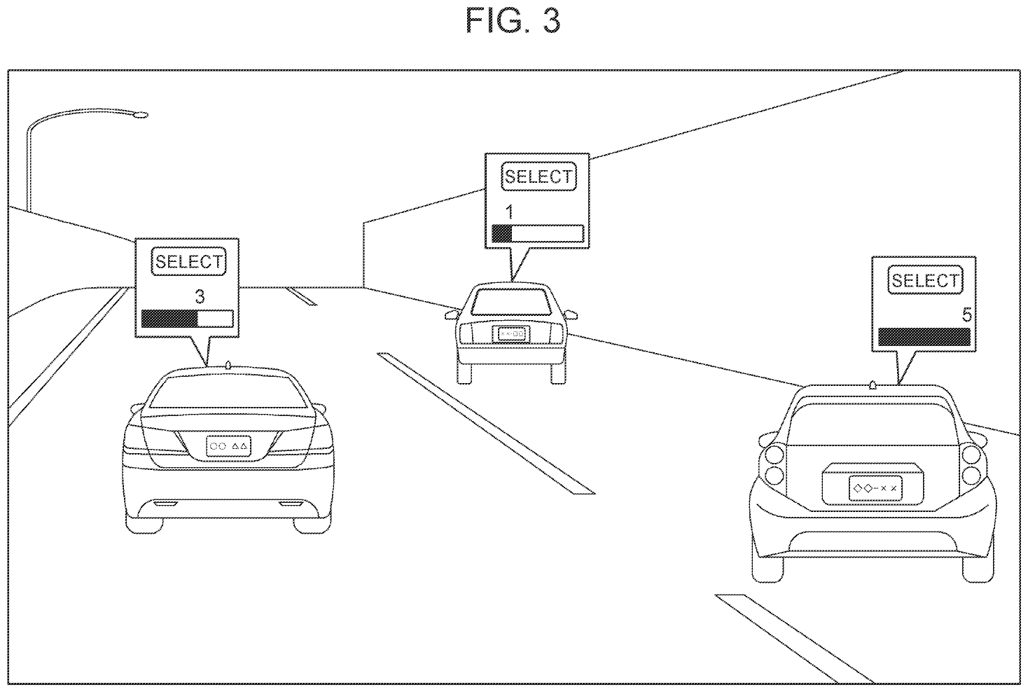

FIG. 3 is a schematic diagram illustrating an exemplary traveling image that is output on the output unit 35 of the second vehicle 30 in FIG. 2. For example, as illustrated in FIG. 3, on the traveling image that is output on the output unit 35, a “Select” button through which the occupant of the second vehicle 30 specifies the first vehicle 20 as an evaluation object is displayed so as to be superposed on each of a plurality of first vehicles 20. In addition, an evaluation bar through which the occupant of the second vehicle 30 performs the five-grade evaluation for the specified first vehicle 20 is displayed so as to be superposed on each of the plurality of first vehicles 20.

The process that is executed to the traveling image by the control unit 36 is not limited to the example in FIG. 3. For example, the control unit 36 may display an item to which the occupant of the second vehicle 30 inputs a score of 0 points to 100 points, such that the item is superposed on each of the plurality of first vehicles 20, instead of or in addition to the evaluation bar through which the occupant of the second vehicle 30 performs the five-grade evaluation. For example, the control unit 36 may display a “Like” button and the number of times the occupant pressed the “Like” button, such that the “Like” button and the number of times are superposed on each of the plurality of first vehicles 20, instead of or in addition to the evaluation bar through which the occupant of the second vehicle 30 performs the five-grade evaluation. For example, the control unit 36 may display “Like” buttons corresponding to evaluation degrees such as “Very Like” and “Like”, such that the “Like” buttons are superposed on each of the plurality of first vehicles 20, instead of or in addition to the evaluation bar through which the occupant of the second vehicle 30 performs the five-grade evaluation.

The control unit 36 acquires, from the input unit 34, the evaluation information that is information about the evaluation of the driving of the first vehicle 20 and that the occupant of the second vehicle 30 inputs using the input unit 34 based on the traveling image output on the output unit 35. The control unit 36 sends the evaluation information acquired by the input unit 34, to the information processing device 10, through the communication unit 31 and the network 50.

In addition, the control unit 36 acquires identification information about the first vehicle 20 that is specified as the evaluation object by the occupant of the second vehicle 30 using the input unit 34, based on the traveling image picked up by the outside-vehicle camera of the acquisition unit 33. The control unit 36 sends the acquired identification information about the first vehicle 20, to the information processing device 10, through the communication unit 31 and the network 50.

In the present specification, for example, the “identification information” includes the number information of the number plate of the first vehicle 20 that is specified from the traveling image taken by the outside-vehicle camera of the second vehicle 30. For example, the “identification information” includes the numbers on the number plate of the first vehicle 20. Without being limited to this, for example, the “identification information” may include an arbitrary identification number that is associated with the numbers on the number plate of the first vehicle 20. In the present specification, for example, the “identification number” includes an arbitrary number that is obtained by conversion with a predetermined protocol that is previously set between the information processing device 10 and the second vehicle 30.

The control unit 36 acquires the position information about the second vehicle 30, using the acquisition unit 33. The control unit 36 sends the position information about the second vehicle 30 acquired by the acquisition unit 33, to the information processing device 10, through the communication unit 31 and the network 50.

Next, the configuration of the terminal device 40 included in the information processing system 1 will be mainly described. As illustrated in FIG. 2, the terminal device 40 includes a communication unit 41, a storage unit 42, an input unit 43, an output unit 44, and a control unit 45.

The communication unit 41 includes a communication module that performs connection to the network 50. For example, the communication unit 41 may include a communication module that supports a mobile communication standard such as 4G and 5G, or an Internet standard. The terminal device 40 is connected to the network 50 through the communication unit 41. The communication unit 41 sends and receives a variety of information through the network 50.

The storage unit 42 is a semiconductor memory, a magnetic memory or an optical memory, for example, but is not limited to them. For example, the storage unit 42 may function as a main storage device, an auxiliary storage device or a cache memory. The storage unit 42 stores arbitrary information that is used for the operation of the terminal device 40. For example, the storage unit 42 may store a system program, an application program, a variety of information received by the communication unit 41, and the like. For example, the information stored in the storage unit 42 may be updated to information that is received from the network 50 through the communication unit 41.

The input unit 43 includes one or more input interfaces that acquire input information based on a user's operation by detecting a user's input. For example, the input unit 43 is a physical key, a capacitance key, a touchscreen that is provided integrally with a display of the output unit 44, a microphone that accepts a voice input, or the like, but is not limited to them.

The output unit 44 includes one or more output interfaces that output information and give notice to the user. For example, the output unit 44 is a display that outputs information as a picture, a speaker that outputs information as a voice, or the like, but is not limited to them.

The control unit 45 includes one or more processors. The “processor” is a general-purpose processor, or a processor dedicated for a particular process, but is not limited to them. The control unit 45 is communicably connected to constituent units that constitute the terminal device 40, and controls the whole operation of the terminal device 40.

The control unit 45 may receive the information about the premium that is the premium of the automobile insurance for the driver of the first vehicle 20 and that is decided by the information processing device 10, from the information processing device 10, through the network 50 and the communication unit 41.

Based on the received information about the premium, the control unit 45 outputs the premium that is the premium of the automobile insurance for the driver of the first vehicle 20 and that is decided by the information processing device 10, on the output unit 44. The staff of the insurance company checks the premium of the automobile insurance that is a notice given to the output unit 44, and accepts the premium using the input unit 43, if there is no problem. Alternatively, the staff of the insurance company checks the premium of the automobile insurance that is a notice given to the output unit 44, and rejects the premium using the input unit 43, if there is a problem. At this time, the control unit 45 acquires, from the input unit 43, information indicating that the premium of the automobile insurance that is decided by the information processing device 10 is accepted or rejected.

The control unit 45 provides the information that indicates the acceptance or rejection and that is acquired from the input unit 43, to the information processing device 10. For example, the control unit 45 sends the information that indicates the acceptance or rejection and that is acquired from the input unit 43, to the information processing device 10, through the communication unit 41 and the network 50.

Next, the configuration of the information processing device 10 included in the information processing system 1 will be mainly described. As illustrated in FIG. 2, the information processing device 10 includes a communication unit 11, a storage unit 12, and a control unit 13.

The communication unit 11 includes a communication module that performs connection to the network 50. For example, the communication unit 11 may include a communication module that supports a mobile communication standard such as 4G and 5G, or an Internet standard. The information processing device 10 is connected to the network 50 through the communication unit 11. The communication unit 11 sends and receives a variety of information through the network 50.

The storage unit 12 is a semiconductor memory, a magnetic memory or an optical memory, for example, but is not limited to them. For example, the storage unit 12 may function as a main storage device, an auxiliary storage device or a cache memory. The storage unit 12 stores arbitrary information that is used for the operation of the information processing device 10. For example, the storage unit 12 may store a system program, an application program, a variety of information received by the communication unit 11, and the like. For example, the information stored in the storage unit 12 may be updated to information that is received from the network 50 through the communication unit 11.

The control unit 13 includes one or more processors. The “processor” is a general-purpose processor, or a processor dedicated for a particular process, but is not limited to them. The control unit 13 is communicably connected to constituent units that constitute the information processing device 10, and controls the whole operation of the information processing device 10.

The control unit 13 receives the traveling information acquired by the acquisition unit 23 of the first vehicle 20 and the position information about the first vehicle 20, from the first vehicle 20, through the network 50 and the communication unit 11. Similarly, the control unit 13 receives the evaluation information acquired by the input unit 34 of the second vehicle 30 and the position information about the second vehicle 30 acquired by the acquisition unit 33, from the second vehicle 30, through the network 50 and the communication unit 11. In addition, the control unit 13 receives the identification information acquired based on the traveling image picked up by the outside-vehicle camera of the acquisition unit 33 of the second vehicle 30, from the second vehicle 30, through the network 50 and the communication unit 11.

Thus, the control unit 13 acquires the traveling information that is obtained in association with the driving of the first vehicle 20, and the evaluation information about the evaluation of the driving of the first vehicle 20 by the occupant of the second vehicle 30 that travels in the periphery of the first vehicle 20. In addition, the control unit 13 acquires the identification information about the first vehicle 20 by the specification of the first vehicle 20 by the occupant of the second vehicle 30.

The control unit 13 executes the comparison process of the acquired traveling information and the acquired evaluation information. For example, in the comparison process, the control unit 13 may specify the first vehicle 20 based on the acquired identification information. More specifically, the control unit 13 may specify the first vehicle 20 that is evaluated by the occupant of the second vehicle 30, by collating the individual information included in the position information acquired from the first vehicle 20 and the identification information acquired from the second vehicle 30 with each other.

For example, in the comparison process, the control unit 13 determines whether the traveling information about the specified first vehicle 20 matches the evaluation information. When the control unit 13 determines that the traveling information about the specified first vehicle 20 matches the evaluation information, the control unit 13 decides the premium of the automobile insurance for the driver of the first vehicle 20. When the control unit 13 determines that the traveling information about the specified first vehicle 20 does not match the evaluation information, the control unit 13 does not execute the premium decision process.

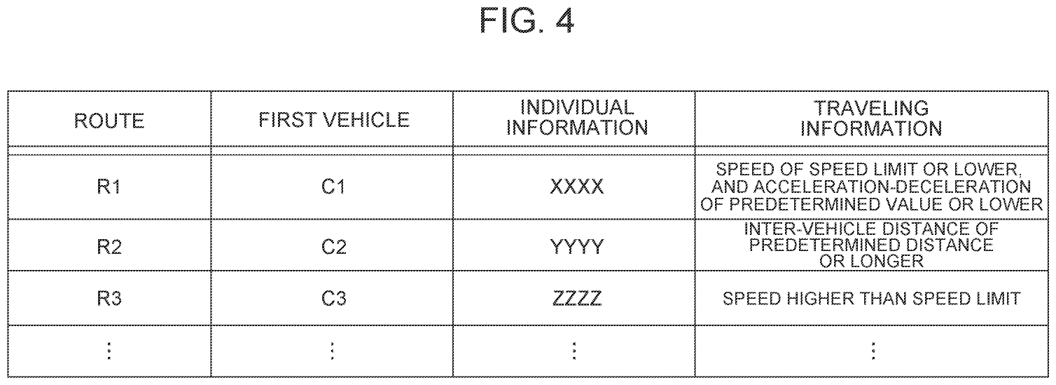

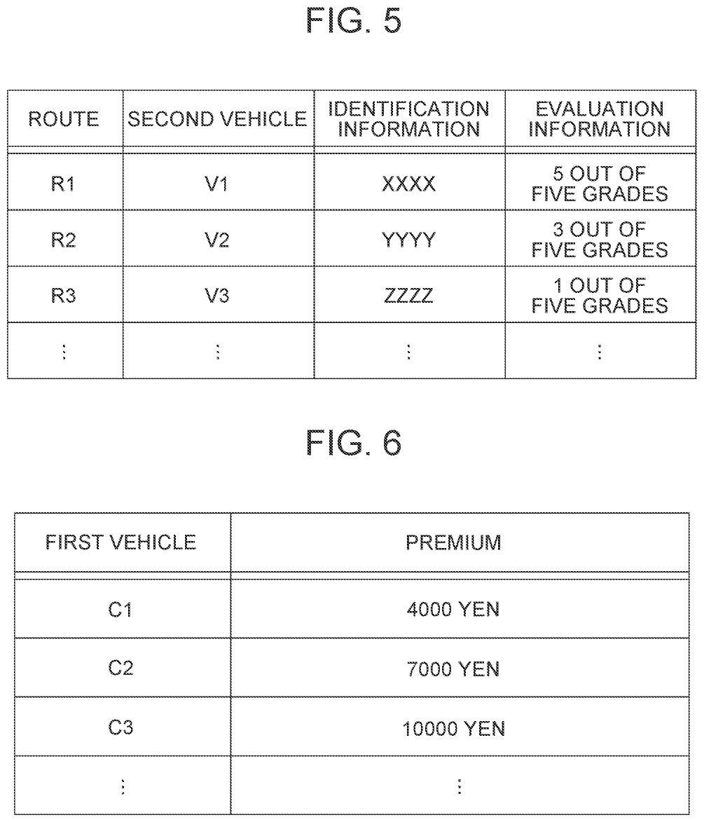

FIG. 4 is a first diagram for describing an exemplary process by the control unit 13 of the information processing device 10 in FIG. 2. FIG. 5 is a second diagram for describing the exemplary process by the control unit 13 of the information processing device 10 in FIG. 2. FIG. 6 is a third diagram for describing the exemplary process by the control unit 13 of the information processing device 10 in FIG. 2. An exemplary process in which the control unit 13 decides the premium of the automobile insurance for the driver of the first vehicle 20 based on the comparison process by the control unit 13 will be more specifically described with reference to FIG. 4 to FIG. 6.

In the exemplary process by the control unit 13, the premium of the automobile insurance for the driver of the first vehicle 20 is decided based on the traveling information and evaluation information acquired by the control unit 13. In FIG. 4 to FIG. 6, three first vehicles C1, C2, C3 are illustrated, but the number of first vehicles 20 corresponding to a plurality of premiums that are decided by the control unit 13 does not need to be three. For example, in FIG. 4, only one first vehicle 20 is illustrated for one route, but the number of first vehicles 20 that travel along one route may be two or more. At this time, the control unit 13 acquires the traveling information and the position information about the first vehicle 20, for each of a plurality of first vehicles 20 that travel along one route.

With reference to FIG. 4, the control unit 13 specifies a route R1 based on the position information acquired from the first vehicle C1. In addition, the control unit 13 acquires information of “XXXX”, as the individual information about the first vehicle C1 that is included in the position information acquired from the first vehicle C1. At this time, the control unit 13 acquires information indicating that the first vehicle C1 is traveling at a speed of a speed limit or lower and is traveling at an acceleration-deceleration of a predetermined value or lower, as the traveling information that is obtained in association with the driving of the first vehicle C1.

With reference to FIG. 5, the control unit 13 acquires information of “XXXX”, from a second vehicle V1 that travels in the periphery of the first vehicle C1 on the route R1, as the identification information about the first vehicle 20 that is specified as the evaluation object by the occupant of the second vehicle V1. At this time, the control unit 13 acquires information of “5” in the five-grade evaluation, as the evaluation information about the driving of the first vehicle 20.

In the comparison process, the control unit 13 may specify the first vehicle 20 that is evaluated by the occupant of the second vehicle V1, by collating the individual information included in the position information acquired from each of a plurality of first vehicles 20 that travels along the route R1 and the identification information acquired from the second vehicle V1 with each other. For example, the control unit 13 determines that the individual information of “XXXX” about the first vehicle C1 of the plurality of first vehicles 20 that travel along the route R1 coincides with the identification information of “XXXX” that is acquired from the second vehicle V1. Thereby, the control unit 13 specifies that the first vehicle C1 is the first vehicle 20 that is evaluated by the occupant of the second vehicle V1.

In the comparison process, the control unit 13 determines whether the traveling information about the specified first vehicle C1 matches the evaluation information. For example, the occupant of the second vehicle V1 recognizes that the first vehicle C1 complies with the speed limit and is traveling without sudden starting and sudden braking, and inputs evaluation information of “5” in the five-grade evaluation. The control unit 13 determines that the traveling information indicating that the first vehicle C1 is traveling at a speed of the speed limit or lower and is traveling at an acceleration-deceleration of the predetermined value or lower, matches information as highly evaluated. Thereby, for example, as illustrated in FIG. 6, the control unit 13 decides that the premium of the automobile insurance for the driver of the first vehicle C1 is 4000 yen, which is the lowest premium.

With reference to FIG. 4, the control unit 13 specifies a route R2 based on the position information acquired from the first vehicle C2. In addition, the control unit 13 acquires information of “YYYY”, as the individual information about the first vehicle C2 that is included in the position information acquired from the first vehicle C2. At this time, the control unit 13 acquires information indicating that the first vehicle C2 is traveling while keeping an inter-vehicle distance of a predetermined distance or longer, as the traveling information that is obtained in association with the driving of the first vehicle C2.

With reference to FIG. 5, the control unit 13 acquires information of “YYYY”, from a second vehicle V2 that travels in the periphery of the first vehicle C2 on the route R2, as the identification information about the first vehicle 20 that is specified as the evaluation object by the occupant of the second vehicle V2. At this time, the control unit 13 acquires information of “3” in the five-grade evaluation, as the evaluation information about the driving of the first vehicle 20.

In the comparison process, the control unit 13 may specify the first vehicle 20 that is evaluated by the occupant of the second vehicle V2, by collating the individual information included in the position information acquired from each of a plurality of first vehicles 20 that travel along the route R2 and the identification information acquired from the second vehicle V2 with each other. For example, the control unit 13 determines that the individual information of “YYYY” about the first vehicle C2 of the plurality of first vehicles 20 that travel along the route R2 coincides with the identification information of “YYYY” that is acquired from the second vehicle V2. Thereby, the control unit 13 specifies that the first vehicle C2 is the first vehicle 20 that is evaluated by the occupant of the second vehicle V2.

In the comparison process, the control unit 13 determines whether the traveling information about the specified first vehicle C2 matches the evaluation information. For example, the occupant of the second vehicle V2 recognizes that the first vehicle C2 is keeping a moderate inter-vehicle distance, and inputs evaluation information of “3” in the five-grade evaluation. The control unit 13 determines that the traveling information indicating that the first vehicle C2 is keeping an inter-vehicle distance of the predetermined distance or longer, matches information evaluated as a middle level. Thereby, for example, as illustrated in FIG. 6, the control unit 13 decides that the premium of the automobile insurance for the driver of the first vehicle C2 is 7000 yen, which is a middle-level premium.

With reference to FIG. 4, the control unit 13 specifies a route R3 based on the position information acquired from the first vehicle C3. In addition, the control unit 13 acquires information of “ZZZZ”, as the individual information about the first vehicle C3 that is included in the position information acquired from the first vehicle C3. At this time, the control unit 13 acquires information indicating that the first vehicle C3 is traveling at a speed higher than a speed limit, as the traveling information that is obtained in association with the driving of the first vehicle C3.

With reference to FIG. 5, the control unit 13 acquires information of “ZZZZ”, from a second vehicle V3 that travels in the periphery of the first vehicle C3 on the route R3, as the identification information about the first vehicle 20 that is specified as the evaluation object by the occupant of the second vehicle V3. At this time, the control unit 13 acquires information of “1” in the five-grade evaluation, as the evaluation information about the driving of the first vehicle 20.

In the comparison process, the control unit 13 may specify the first vehicle 20 that is evaluated by the occupant of the second vehicle V3, by collating the individual information included in the position information acquired from each of a plurality of first vehicles 20 that travel along the route R3 and the identification information acquired from the second vehicle V3 with each other. For example, the control unit 13 determines that the individual information of “ZZZZ” about the first vehicle C3 of the plurality of first vehicles 20 that travel along the route R3 coincides with the identification information of “ZZZZ” that is acquired from the second vehicle V3. Thereby, the control unit 13 specifies that the first vehicle C3 is the first vehicle 20 that is evaluated by the occupant of the second vehicle V3.

In the comparison process, the control unit 13 determines whether the traveling information about the specified first vehicle C3 matches the evaluation information. For example, the occupant of the second vehicle V3 recognizes that the first vehicle C3 does not comply with the speed limit, and inputs evaluation information of “1” in the five-grade evaluation. The control unit 13 determines that the traveling information indicating that the first vehicle C3 is traveling at a speed higher than the speed limit, matches information evaluated as low. Thereby, for example, as illustrated in FIG. 6, the control unit 13 decides that the premium of the automobile insurance for the driver of the first vehicle C3 is 10000 yen, which is the highest premium.

The control unit 13 may give notice of the premium decided in this way, to the insurance company that provides the automobile insurance. For example, the control unit 13 may send the information about the premium to the terminal device 40 through the communication unit 11 and the network 50. The control unit 13 may determine whether the insurance company has accepted the decided premium. For example, the control unit 13 may receive the information about the acceptance or rejection of the decided premium, from the terminal device 40, through the network 50 and the communication unit 11, and may execute the above determination process.

When the control unit 13 determines that the insurance company has accepted the decided premium, the control unit 13 may give notice of the premium to the driver of the first vehicle 20. For example, the control unit 13 may send the information about the decided premium to the first vehicle 20 through the communication unit 11 and the network 50.

When the control unit 13 determines that the premium decided in the above way has reached a threshold value, the control unit 13 may decide a driving method that allows the premium to be decreased. In the present specification, for example, the “threshold value” includes a predetermined value that is set for the premium. For example, the “threshold value” is previously set by the driver of the first vehicle 20, an administrator of the information processing system 1 or the staff of the insurance company, before the first vehicle 20 is added to the information processing system 1 and the use of the first vehicle 20 is started. Without being limited to this, for example, the “threshold value” may be set by the driver of the first vehicle 20, the administrator of the information processing system 1 or the staff of the insurance company, when necessary, after the use of the first vehicle 20 is started. In the present specification, for example, the “driving method” includes compliance with the speed limit, keeping of a moderate inter-vehicle distance, restraints in sudden starting and sudden braking, and the like.

The control unit 13 may give notice of the driving method decided in this way, to the driver of the first vehicle 20. For example, the control unit 13 may send information about the decided driving method, to the first vehicle 20, through the communication unit 11 and the network 50.

In addition, the control unit 13 may decide an incentive to be given to the occupant of the second vehicle 30 that properly evaluates the driving of the first vehicle 20. In the present specification, for example, the “incentive” includes an arbitrary element that can be a motivation by which the occupant of the second vehicle 30 properly evaluates the driving of the first vehicle 20. For example, the “incentive” includes a reward, a discount coupon, a point and the like.

The control unit 13 may give notice of the decided incentive to the occupant of the second vehicle 30. For example, the control unit 13 may send information about the decided incentive to the second vehicle 30 through the communication unit 11 and the network 50. The incentive may be given whenever the occupant of the second vehicle 30 properly evaluates the driving of the first vehicle 20, or may be given when the number of proper evaluations reaches a prescribed value.

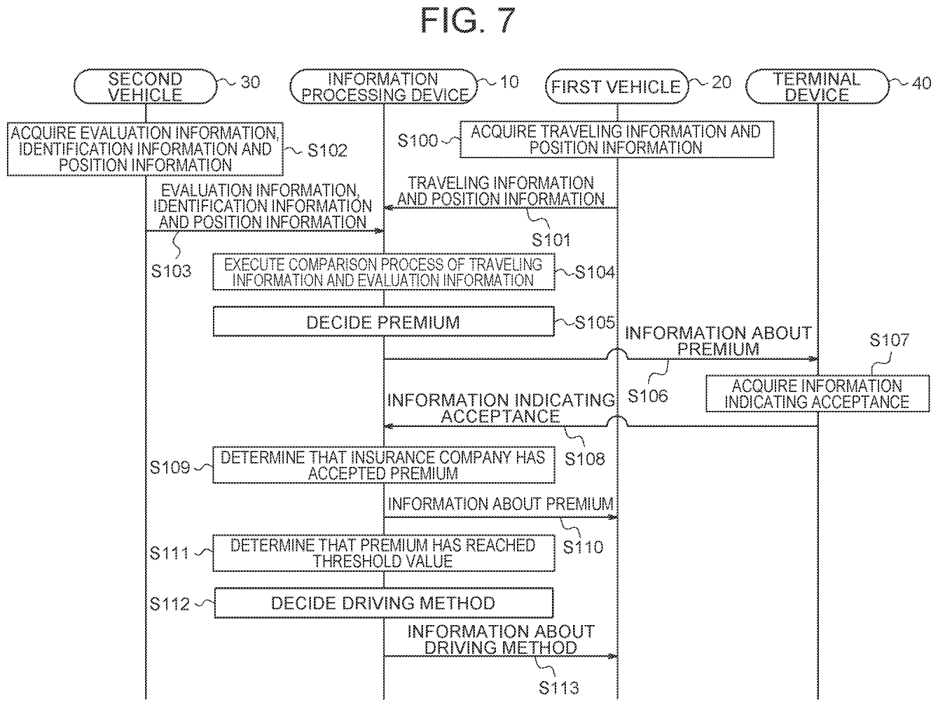

FIG. 7 is a sequence diagram for describing an exemplary information processing method that is executed by the information processing system 1 in FIG. 1. The exemplary information processing method that is executed by the information processing system 1 in FIG. 1 will be described with reference to FIG. 7.

In step S100, the first vehicle 20 acquires the traveling information that is obtained in association with the driving of the first vehicle 20, using the acquisition unit 23. The first vehicle 20 acquires the position information about the first vehicle 20, using the acquisition unit 23.

In step S101, the first vehicle 20 sends the traveling information and the position information about the first vehicle 20 that are acquired in step S100, to the information processing device 10, through the communication unit 21 and the network 50.

In step S102, the second vehicle 30 acquires the evaluation information about the driving of the first vehicle 20, from the input unit 34. The second vehicle 30 acquires the identification information about the first vehicle 20 as the evaluation object, based on the traveling image picked up by the outside-vehicle camera of the acquisition unit 33. The second vehicle 30 acquires the position information about the second vehicle 30, using the acquisition unit 33.

In step S103, the second vehicle 30 sends the evaluation information, the identification information and the position information about the second vehicle 30 that are acquired in step S102, to the information processing device 10, through the communication unit 31 and the network 50.

In step S104, the information processing device 10 executes the comparison process of the traveling information acquired in step S101 and the evaluation information acquired in step S103.

In step S105, the information processing device 10 decides the premium of the automobile insurance for the driver of the first vehicle 20, based on the comparison process in step S104.

In step S106, the information processing device 10 sends the information about the premium decided in step S105, to the terminal device 40, through the communication unit 11 and the network 50.

In step S107, the terminal device 40 acquires the information that indicates the acceptance of the premium acquired in step S106.

In step S108, the terminal device 40 sends the information that indicates the acceptance of the premium and that is acquired in step S107, to the information processing device 10, through the communication unit 41 and the network 50.

In step S109, the information processing device 10 determines that the insurance company has accepted the premium decided in step S105, by acquiring the information that indicates the acceptance of the premium in step S108.

In step S110, based on the determination result in step S109, the information processing device 10 sends the information about the premium decided in step S105, to the first vehicle 20, through the communication unit 11 and the network 50.

In step S111, the information processing device 10 determines that the premium decided in step S105 has reached the threshold.

In step S112, based on the determination result in step S111, the information processing device 10 decides the driving method that allows the decrease in the premium decided in step S105.

In step S113, the information processing device 10 sends the information about the driving method decided in step S112, to the first vehicle 20, through the communication unit 11 and the network 50.

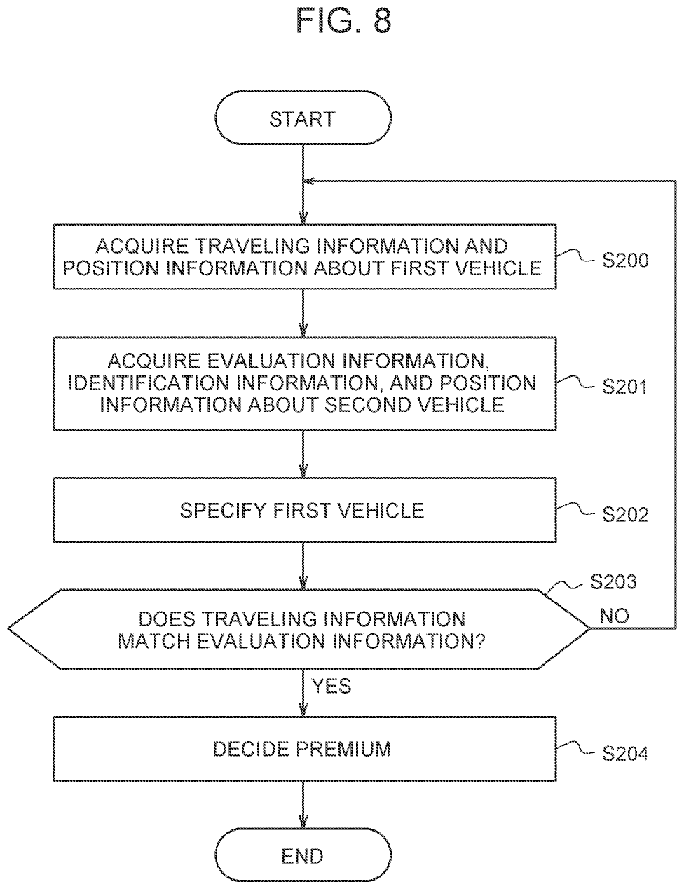

Next, an information processing method that is executed by the control unit 13 of the information processing device 10 according to an embodiment will be described with reference to FIG. 8 to FIG. 10. FIG. 8 is a flowchart for describing a first example of the information processing method that is executed by the information processing device 10 in FIG. 1. In the first example of the information processing method, a basic flow along which the premium of the automobile insurance is decided by the control unit 13 of the information processing device 10 will be described.

In step S200, the control unit 13 acquires the traveling information that is obtained in association with the driving of the first vehicle 20, from the first vehicle 20. The control unit 13 acquires the position information about the first vehicle 20, from the first vehicle 20.

In step S201, the control unit 13 acquires the evaluation information about the evaluation of the driving of the first vehicle 20 by the occupant of the second vehicle 30 that travels in the periphery of the first vehicle 20, from the second vehicle 30. The control unit 13 acquires the identification information about the first vehicle 20 from the second vehicle 30, by the specification of the first vehicle 20 by the occupant of the second vehicle 30. The control unit 13 acquires the position information about the second vehicle 30 from the second vehicle 30.

The control unit 13 executes the comparison process of the traveling information acquired in step S200 and the evaluation information acquired in step S201.

More specifically, in step S202, in the comparison process, the control unit 13 specifies the first vehicle 20 based on the identification information acquired in step S201.

In step S203, in the comparison process, the control unit 13 determines whether the traveling information about the first vehicle 20 specified in step S202 matches the evaluation information. When the control unit 13 determines that the traveling information about the first vehicle 20 matches the evaluation information, the control unit 13 executes a process of step S204. When the control unit 13 determines that the traveling information about the first vehicle 20 does not match the evaluation information, the control unit 13 executes the process of step S200 again.

In step S204, the control unit 13 decides the premium of the automobile insurance for the driver of the first vehicle 20, based on the comparison process. More specifically, when the control unit 13 determines that the traveling information about the first vehicle 20 matches the evaluation information in step S203, the control unit 13 decides the premium.

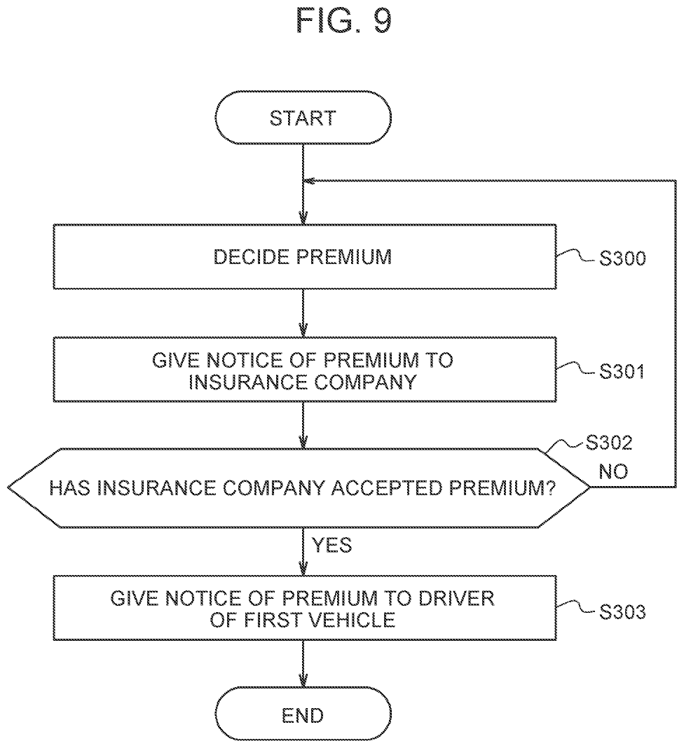

FIG. 9 is a flowchart for describing a second example of the information processing method that is executed by the information processing device 10 in FIG. 1. In the second example of the information processing method, a flow relevant to the notice of the premium after the premium of the automobile insurance is decided by the control unit 13 of the information processing device 10 will be described.

In step S300, the control unit 13 decides the premium of the automobile insurance for the driver of the first vehicle 20, in accordance with the flow illustrated in FIG. 8.

In step S301, the control unit 13 gives notice of the premium decided in step S300, to the insurance company that provides the automobile insurance.

In step S302, the control unit 13 determines whether the insurance company has accepted the premium decided in step S300. When the control unit 13 determines that the insurance company has accepted the premium, the control unit 13 executes a process of step S303. When the control unit 13 determines that the insurance company has not accepted the premium, the control unit 13 executes the process of step S300 again. That is, the control unit 13 decides the premium of the automobile insurance for the driver of the first vehicle 20 again, in accordance with the flow illustrated in FIG. 8.

In step S303, when the control unit 13 determines that the insurance company has accepted the premium in step S302, the control unit 13 gives notice of the premium decided in step S300, to the driver of the first vehicle 20.

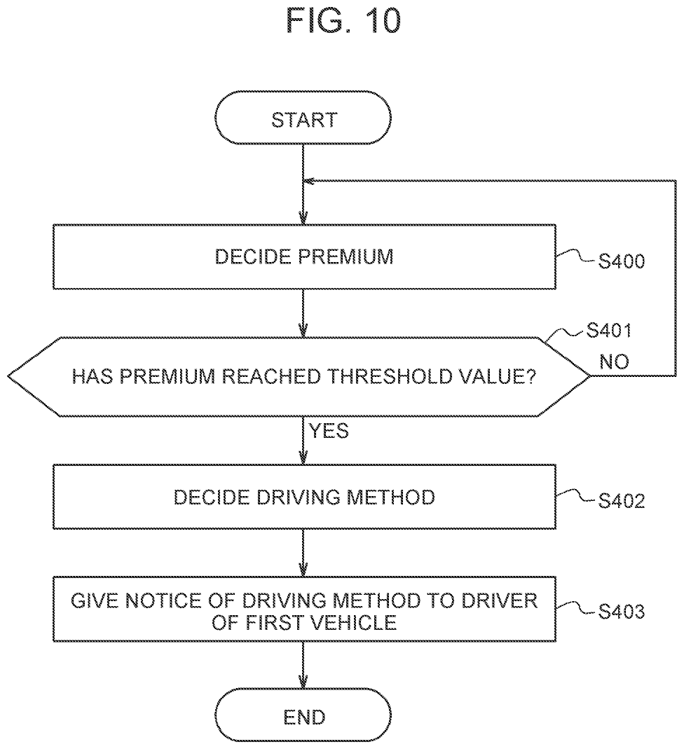

FIG. 10 is a flowchart for describing a third example of the information processing method that is executed by the information processing device 10 in FIG. 1. In the third example of the information processing method, a flow relevant to the notice of the driving method after the premium of the automobile insurance is decided by the control unit 13 of the information processing device 10 will be described.

In step S400, the control unit 13 decides the premium of the automobile insurance for the driver of the first vehicle 20, in accordance with the flow illustrated in FIG. 8.

In step S401, the control unit 13 determines whether the premium decided in step S400 has reached the threshold value. When the control unit 13 determines that the premium has reached the threshold value, the control unit 13 executes a process of step S402. When the control unit 13 determines that the premium has not reached the threshold value, the control unit 13 executes the process of step S400 again. That is, the control unit 13 decides the premium of the automobile insurance for the driver of the first vehicle 20 again, in accordance with the flow illustrated in FIG. 8.

In step S402, when the control unit 13 determines that the premium has reached the threshold value in step S401, the control unit 13 decides the driving method that allows the premium to be decreased.

In step S403, the control unit 13 gives notice of the driving method decided in step S402, to the driver of the first vehicle 20.

With the embodiment described above, it is possible to enhance the objectivity of the premium of the automobile insurance that is decided for the driver of the first vehicle 20. For example, the information processing device 10 decides the premium based on the comparison process of the traveling information acquired from the first vehicle 20 and the evaluation information acquired from the second vehicle 30. By comparing the actual traveling information about the first vehicle 20 with the evaluation from another person in the second vehicle 30, the information processing device 10 can enhance the reliability of the premium that is decided. The information processing device 10 can give notice of an objective and probable premium, to the insurance company and the driver of the first vehicle 20. Thus, the insurance company and the driver of the first vehicle 20 have a high satisfying sense about the premium that is presented.

The information processing device 10 specifies the first vehicle 20 based on the acquired identification information, in the comparison process, and thereby can easily execute the process of specifying the first vehicle 20. For example, the information processing device 10 only needs to collate the identification information about the first vehicle 20 that is specified as the evaluation object by the occupant of the second vehicle 30, with the individual information about each of a plurality of first vehicles 20 that travels in the periphery of the second vehicle 30. Thereby, the information processing device 10 can enhance the accuracy of the specification of the first vehicle 20 that is evaluated by the occupant of the second vehicle 30.

When the information processing device 10 determines that the traveling information about the specified first vehicle 20 matches the evaluation information in the comparison process, the information processing device 10 decides the premium. Thereby, the information processing device 10 can enhance the probability of the evaluation of the decided premium by the other person. For example, there is a possibility that the occupant of the second vehicle 30 intentionally evaluates the driving of the first vehicle 20 differently from the actual recognition, or that the occupant of the second vehicle 30 unintentionally evaluates the driving of the first vehicle 20 due to an erroneous operation or the like. In such cases, the information processing device 10 determines that the traveling information does not match the evaluation information, and thereby does not execute the premium decision process. Accordingly, the information processing device 10 can restrain the decision of an uncertain premium that does not match the actual traveling information.

The identification information includes the number information that is the information about the number plate of the first vehicle 20 and that is specified from the traveling image taken by the outside-vehicle camera of the second vehicle 30, and thereby it is possible to enhance the accuracy of the process in which the information processing device 10 specifies the first vehicle 20 using the identification information.

The information processing device 10 gives notice of the decided premium to the insurance company that provides the automobile insurance, and thereby it is possible to check with the insurance company about the appropriateness of the premium that is one-sidedly decided by the information processing device 10. When the information processing device 10 determines that the insurance company has accepted the decided premium, the information processing device 10 gives notice of the premium to the driver of the first vehicle 20, and thereby the information processing device 10 can give notice of only a premium that is satisfied as an appropriate premium by the insurance company, to the driver of the first vehicle 20. Thereby, it is possible to enhance a trust feeling of the driver of the first vehicle 20 about the decided premium.

When the information processing device 10 determines that the premium has reached the threshold, the information processing device 10 decides the driving method that allows the premium to be decreased, and gives notice of the driving method to the driver of the first vehicle 20. Thereby, for example, the information processing device 10 can encourage improvement in the driving method, for the driver of the first vehicle 20 that receives a low evaluation result from the other person and that performs a problematic driving. The driver of the first vehicle 20 actually improves the driving method to receive a higher evaluation result from the other person, and thereby can decrease the premium.

The present disclosure has been described based on the drawings and the embodiment. Note that those skilled in the art can make various modifications and alterations based on the present disclosure. Accordingly, it should be understood that the modifications and the alterations are included in the scope of the present disclosure. For example, functions and others included in the constituents, the steps or others can be rearranged as long as there is no logical inconsistency, and a plurality of constituents, steps or others can be combined into one, or can be divided.

For example, in the above embodiment, at least one or some of the processing operations that are executed in the information processing device 10 may be executed in at least one of the first vehicle 20, the second vehicle 30 and the terminal device 40. At least one or some of the processing operations that are executed in at least one of the first vehicle 20, the second vehicle 30 and the terminal device 40 may be executed in the information processing device 10.

For example, the information processing device 10 described in the above embodiment may be mounted on the first vehicle 20 or the second vehicle 30. At this time, the information processing device 10 may perform information communication directly with the first vehicle 20 or the second vehicle 30, without using the network 50.

For example, instead of the information processing device 10, the first vehicle 20 may execute the above processing operations relevant to the information processing device 10. At this time, the control unit 26 of the first vehicle 20 may acquire the identification information about the first vehicle 20 by the specification of the first vehicle 20 by the occupant of the second vehicle 30, and may determine whether the acquired identification information coincides with the individual information about the first vehicle 20, in the comparison process. When the control unit 26 determines that the acquired identification information coincides with the individual information about the first vehicle 20 and the traveling information about the first vehicle 20 matches the evaluation information in the comparison process, the control unit 26 may decide the premium.

For example, a general-purpose electronic device such as a smartphone or a computer may function as the information processing device 10 according to the above embodiment. Specifically, a program having processing contents that realize the functions of the information processing device 10 and the like according to the embodiment is stored in a memory of the electronic device, and the program is read and executed by a processor of the electronic device. Accordingly, the disclosure of an embodiment can be realized as a program that can be executed by a processor. Alternatively, the disclosure of an embodiment can be realized as a non-transitory computer-readable medium storing a program that can be executed by one or more processors in order to execute the functions of the information processing device 10 and the like according to the present embodiment. It should be understood that the scope of the present disclosure includes the program and the non-transitory computer-readable medium.

In the above embodiment, the information processing device 10 specifies the first vehicle 20 based on the acquired identification information, in the comparison process, but the present disclosure is not limited to this. For example, the information processing device 10 may specify the first vehicle 20 that is the evaluation object, without acquiring the identification information from the second vehicle 30. At this time, for example, the control unit 13 of the information processing device 10 may specify the first vehicle 20 that is associated with the traveling information matching the evaluation information, in the comparison process. For example, the control unit 13 may specify a first vehicle 20 of a plurality of first vehicles 20 traveling in the periphery of the second vehicle 30 and that is highest in the degree of the matching between the evaluation information acquired from the second vehicle 30 and the traveling information about the first vehicle 20, as the first vehicle 20 that is evaluated by the occupant of the second vehicle 30.

Thereby, at the time of the evaluation of the driving of the first vehicle 20, the occupant of the second vehicle 30 only needs to operate the evaluation bar that is displayed at one spot of a screen of the output unit 35, for example, and does not need to press the “Select” button illustrated in FIG. 3. Accordingly, the occupant of the second vehicle 30 can complete the input using the input unit 34, immediately after the occupant recognizes the driving of the first vehicle 20. That is, the occupant of the second vehicle 30 can more simply perform the input operation when the occupant evaluates the driving of the first vehicle 20 using the input unit 34. As a result, the occupant of the second vehicle 30 can easily evaluate the driving of the first vehicle 20, so that the effectiveness of the evaluation system based on the information processing system 1 is enhanced.

In the above embodiment, the information processing device 10 decides the premium when the information processing device 10 determines that the traveling information about the specified first vehicle 20 matches the evaluation information in the comparison process, but the present disclosure is not limited to this. For example, the information processing device 10 may decide the premium without executing the determination process of whether the traveling information about the specified first vehicle 20 matches the evaluation information.

In the above embodiment, the information processing device 10 gives notice of the decided premium to the driver of the first vehicle 20 when the information processing device 10 determines that the insurance company has accepted the decided premium, but is not limited to this. For example, the information processing device 10 may give notice of the decided premium to the driver of the first vehicle 20, without executing the determination process of whether the insurance company has accepted the decided premium.

In the above embodiment, the information processing device 10 decides the driving method and gives notice of the driving method to the driver of the first vehicle 20, when the information processing device 10 determines that the premium has reached the threshold value, but the present disclosure is not limited to this. For example, the information processing device 10 decides the driving method that allows the premium to be decreased, and gives notice of the driving method to the driver of the first vehicle 20, without executing the determination process of whether the decided premium has reached the threshold value. For example, the information processing device 10 does not need to decide the driving method that allows the premium to be decreased.

For example, the information processing system 1 may include only the information processing device 10, the first vehicle 20 and the second vehicle 30, without including the terminal device 40.

Meanwhile, the information processing system 1 may further include a first terminal device such as a smartphone that is used by an occupant other than the driver of the first vehicle 20. At this time, the first terminal device may execute at least one or some of the above processing operations that are executed in the first vehicle 20. For example, the first terminal device may acquire the evaluation information, the information about the premium and the information about the driving method, from the information processing device 10, and may output the evaluation information, the information about the premium and the information about the driving method, to the occupant of the first vehicle 20.

Meanwhile, the information processing system 1 may further include a second terminal device such as a smartphone that is used by the occupant of the second vehicle 30. At this time, the second terminal device may execute at least one or some of the above processing operations that are executed in the second vehicle 30. For example, the second terminal device may output the traveling image of the second vehicle 30 illustrated in FIG. 3, and may accept the input of the evaluation information about the first vehicle 20 that is evaluated by the occupant of the second vehicle 30. For example, the second terminal device may provide the evaluation information, the identification information and the position information about the second vehicle 30, to the information processing device 10.

In the above embodiment, the second vehicle 30 acquires the evaluation information based on the traveling image of the second vehicle 30 that is output to the output unit 35, but the present disclosure is not limited to this. For example, the second vehicle 30 may acquire the evaluation information about the driving of the first vehicle 20, based on the occupant information acquired by the acquisition unit 33. For example, the second vehicle 30 may acquire the evaluation information based on a conversation content, a behavior and others of the occupant that are relevant to the driving of the first vehicle 20.

What is claimed is:

1. An information processing device comprising a control unit configured to acquire traveling information and evaluation information, and to decide a premium of an automobile insurance for a driver of a first vehicle, based on a comparison process of the acquired traveling information and the acquired evaluation information, the traveling information being obtained in association with driving of the first vehicle, the evaluation information being information about evaluation of the driving of the first vehicle by an occupant of a second vehicle that travels in a periphery of the first vehicle.

2. The information processing device according to claim 1, wherein the control unit acquires identification information about the first vehicle by specification of the first vehicle by the occupant of the second vehicle, and specifies the first vehicle based on the acquired identification information in the comparison process.

3. The information processing device according to claim 2, wherein the control unit decides the premium when the control unit determines that the traveling information about the specified first vehicle matches the evaluation information in the comparison process.

4. The information processing device according to claim 2, wherein the identification information includes number information of a number plate of the first vehicle, the number information being specified from a traveling image that is taken by an outside-vehicle camera of the second vehicle.

5. The information processing device according to claim 1, wherein the control unit specifies the first vehicle that is associated with the traveling information matching the evaluation information, in the comparison process.

6. The information processing device according to claim 1, wherein the control unit gives notice of the decided premium to an insurance company that provides the automobile insurance, and when the control unit determines that the insurance company has accepted the premium, the control unit gives notice of the premium to the driver of the first vehicle.

7. The information processing device according to claim 1, wherein when the control unit determines that the premium has reached a threshold value, the control unit decides a driving method that allows the premium to be decreased, and gives notice of the driving method to the driver of the first vehicle.

8. An information processing system comprising:
the information processing device according to claim 1;
the first vehicle that provides the traveling information to the information processing device; and
the second vehicle that provides the evaluation information to the information processing device.

9. A program that causes an information processing device to execute an operation including:
acquiring traveling information, the traveling information being obtained in association with driving of a first vehicle:
acquiring evaluation information, the evaluation information being information about evaluation of the driving of the first vehicle by an occupant of a second vehicle that travels in a periphery of the first vehicle;
executing a comparison process of the acquired traveling information and the acquired evaluation information; and
deciding a premium of an automobile insurance for a driver of the first vehicle, based on the comparison process.

10. The program according to claim 9, wherein the operation includes:
acquiring identification information about the first vehicle by specification of the first vehicle by the occupant of the second vehicle; and
specifying the first vehicle based on the acquired identification information in the comparison process.

11. The program according to claim 10, wherein the operation includes deciding the premium when the information processing device determines that the traveling information about the specified first vehicle matches the evaluation information in the comparison process.

12. The program according to claim 10, wherein the identification information includes number information of a number plate of the first vehicle, the number information being specified from a traveling image that is taken by an outside-vehicle camera of the second vehicle.

13. The program according to claim 9, wherein the operation includes specifying the first vehicle that is associated with the traveling information matching the evaluation information, in the comparison process.

14. The program according to claim 9, wherein the operation includes:
giving notice of the decided premium to an insurance company that provides the automobile insurance;
determining whether the insurance company has accepted the premium; and
giving notice of the premium to the driver of the first vehicle, when it is determined that the insurance company has accepted the premium.

15. The program according to claim 9, wherein the operation includes:
determining whether the premium has reached a threshold value;
deciding a driving method that allows the premium to be decreased, when it is determined that the premium has reached the threshold value; and
giving notice of the decided driving method to the driver of the first vehicle.

16. A vehicle comprising a control unit configured to acquire traveling information and evaluation information, and to decide a premium of an automobile insurance for a driver of the vehicle, based on a comparison process of the acquired traveling information and the acquired evaluation information, the traveling information being obtained in association with driving of the vehicle, the evaluation information being information about evaluation of the driving of the vehicle by an occupant of another vehicle that travels in a periphery of the vehicle.

17. The vehicle according to claim 16, wherein the control unit acquires identification information about the vehicle by specification of the vehicle by the occupant of the other vehicle, and determines whether the acquired identification information coincides with individual information about the vehicle in the comparison process.

18. The vehicle according to claim 17, wherein the control unit decides the premium when the control unit determines that the acquired identification information coincides with the individual information about the vehicle and that the traveling information about the vehicle matches the evaluation information in the comparison process.

19. The vehicle according to claim 16, wherein the control unit gives notice of the decided premium to an insurance company that provides the automobile insurance, and when the control unit determines that the insurance company has accepted the premium, the control unit gives notice of the premium to the driver of the vehicle.

20. The vehicle according to claim 16, wherein when the control unit determines that the premium has reached a threshold value, the control unit decides a driving method that allows the premium to be decreased, and gives notice of the driving method to the driver of the vehicle.
